(19) United States
(12) Patent Application Publication
(10) Pub. No.: US 2017/0298519 A1
(43) Pub. Date: Oct. 19, 2017

(54) DOUBLE-LAYERED ZIRCONIUM OXIDE LAYER HAVING A HIGH-PURITY CONTENT

(71) Applicant: Siemens Aktiengesellschaft, Munchen (DE)

(72) Inventors: Christopher Degel, Berlin (DE); Adrian Wollnik, Dallgow-Döberitz (DE)

(21) Appl. No.: 15/514,604

(22) PCT Filed: Sep. 30, 2015
(86) PCT No.: PCT/EP2015/072538

§ 371 Date: Mar. 27, 2017

(30) Foreign Application Priority Data
Oct. 8, 2014 (DE) 102014220359.7

(51) Int. Cl. C23C 28/00; F01D 25/00

(52) U.S. Cl. CPC C23C 28/3455; C23C 28/3215; F01D 25/005; F05D 2300/5023; F05D 2300/2118

(57) ABSTRACT

By the use of highly pure zirconium oxide material for the outermost thermal barrier coating of a two-layer thermal barrier coating system, improved and durable layer systems for high-temperature temperature use is provided. A ceramic thermal barrier layer system, comprising: a substrate, a metallic adhesion-promoting layer on the substrate, an inner ceramic layer on the adhesion-promoting layer, and an outer ceramic layer on the inner ceramic layer, wherein the inner ceramic layer and the outer ceramic layer together represent the ceramic thermal barrier layer on the adhesion-promoting layer, wherein the outer ceramic layer is at least 20% purer, than the inner ceramic layer in terms of its chemical composition.

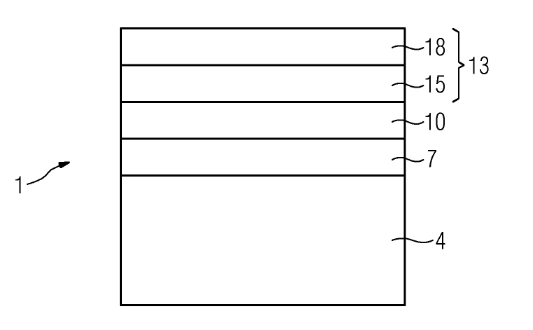

### CROSS-REFERENCE TO RELATED APPLICATIONS

This application claims priority to PCT Application No. PCT/EP2015/072538, having a filing date of Sep. 30, 2015, based off of German application No. DE 102014220359.7 having a filing date of Oct. 8, 2014, the entire contents of which are both hereby incorporated by reference.

### FIELD OF TECHNOLOGY

The following relates to a two-coat ceramic thermal barrier layer using high-purity zirconium oxide.

### BACKGROUND

In order to withstand the ever higher temperatures in the gas stream of the most recent generations of gas turbines, there is a need for ever more high-performance technologies protecting the gas turbine components. This includes the use of high-temperature superalloys, the use of film cooling and coating the components with oxidation and thermal barrier layers.

Modern gas turbine components are frequently provided with a layer of partially stabilized zirconium oxide (8YSZ) and gadolinium zirconate (GZO). GZO is advantageous because the heat transfer coefficient of GZO is lower than that of 8YSZ, and the sintering tendency is lower. However, GZO powder is more costly.

### SUMMARY

An aspect relates to solving the aforementioned problem.

The layer system provides a ceramic thermal barrier layer system, having at least: a substrate, a metallic adhesion-promoting layer on the substrate, in particular directly on the substrate, optionally an aluminum oxide layer or an oxide layer grown from the adhesion-promoting layer, directly on the metallic adhesion-promoting layer, an inner ceramic layer on the adhesion-promoting layer, and an outer, in particular outermost, ceramic layer on the inner ceramic layer, wherein the inner ceramic layer and the outer ceramic layer together represent the ceramic thermal barrier layer on the adhesion-promoting layer, wherein the outer ceramic layer is at least 20% purer, in particular at least 50% purer, than the inner ceramic layer in terms of its chemical composition.

### BRIEF DESCRIPTION

Some of the embodiments will be described in detail, with reference to the following figures, wherein like designations denote like members, wherein:

The figure shows a diagram of a layer system.

### DETAILED DESCRIPTION

The figure and the description represent only exemplary embodiments of the invention. Nickel- or cobalt-based superalloys are used as the substrate 4 of a ceramic thermal barrier layer system 1, in particular in the context of turbine components or components for high-temperature applications.

A metallic adhesion-promoting layer 7 is present on the substrate 4, in particular directly on the substrate 4. This is preferably an adhesion-promoting layer 7 consisting of a NiCoCrAlX coating, where X represents rhenium (Re), yttrium (Y), silicon (Si), iron (Fe) and/or tantalum (Ta).

An oxide layer 10 is generated on the metallic adhesion-promoting layer 7, or, when coating with a ceramic coating 13 or during use, an aluminum oxide layer 10 grows as oxidation protection.

A ceramic thermal barrier layer 13, having an inner ceramic layer 15 and an outer ceramic layer 18 on the inner ceramic layer 15, is deposited onto the metallic adhesion-promoting layer 7 or onto the aluminum oxide layer 10.

The outer ceramic layer 18 is preferably also the outermost layer.

The materials for the inner ceramic layer and outer ceramic layer 15 are preferably identical.

The inner ceramic layer 15 preferably has a partially-stabilized zirconium oxide layer, wherein for stabilizing use is preferably made of yttrium (Y), and very preferably only yttrium (Y). The proportion of yttrium (Y) is preferably 8 wt %.

The outer ceramic layer 18 preferably also has zirconium oxide, but is at least 20% purer, in particular at least 50% purer, in terms of chemical impurities than the inner zirconium oxide layer 15.

Here, too, the proportion of yttrium (Y) is preferably 8 wt %. The chemical impurities of the ceramic layers 18, 15 are in particular hafnium oxide and/or aluminum oxide and/or silicon oxide and/or iron oxide and/or titanium oxide and/or magnesium oxide and/or calcium oxide.

The purity can relate to one, more than one or all of the impurities in the powder or in the produced layer.

Thus, a ZrO₂ powder/layer with at least one of 5% less HfO₂, 5% less Al₂O₃, 5% less SiO₂, and 5% less TiO₂ is 20% purer. This is the same when a ZrO₂ powder/layer has 20% less Al₂O₃ and otherwise comparable values for the other impurities.

This holds not only for zirconium oxide, but also if other materials are used for the ceramic layer 13.

Preferably, the outer ceramic thermal barrier layer 18 has a porosity of 16% to 24%, in particular 18% to 22%, very particularly 20%.

The porosity is preferably measured in vol %.

The porosity of the inner ceramic layer (15) is preferably at least 3 vol % lower.

The outer ceramic layer (18) is preferably at least 10%, in particular 20% thicker in order to make better use of the thermal barrier effect.

The lower proportions of impurities—and thus melting point depressants—result in worse sintering properties, and as a result the layer can withstand the higher temperatures while retaining the porosity for longer at higher temperatures.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A ceramic thermal barrier layer system, comprising:
a substrate,
a metallic adhesion-promoting layer on the substrate,
an inner ceramic layer on the adhesion-promoting layer, and
an outer ceramic layer on the inner ceramic layer, wherein the inner ceramic layer and the outer ceramic layer together represent the ceramic thermal barrier layer on the adhesion-promoting layer, wherein the outer ceramic layer is at least 20% purer, than the inner ceramic layer in terms of its chemical composition.

2. The layer system as claimed in claim 1, in which the impurities of the ceramic thermal barrier layer are at least one of hafnium oxide, aluminum oxide, silicon oxide, iron oxide, titanium oxide, magnesium oxide and calcium oxide.

3. The layer system as claimed in claim 1, in which the material of the inner ceramic layer and of the outer ceramic layer is identical.

4. The layer system as claimed in claim 1, in which the outer ceramic thermal barrier layer has a porosity of at least 16%.

5. The layer system as claimed in claim 4, in which the porosity of the outer ceramic layer is between 18% and 22%.

6. The layer system as claimed in claim 1, in which the material of at least one of the inner ceramic layer and of the outer ceramic layer comprises zirconium oxide.

7. (canceled)

8. The layer system as claimed in claim 1, in which the porosity of the inner ceramic layer is at least 3 vol % less than that of the outer ceramic layer.

9. The layer system as claimed in claim 1, in which the ceramic thermal barrier layer has only two coats.

10. The layer system as claimed in claim 1, wherein the outer ceramic thermal barrier layer is at least 10% thicker than the inner ceramic thermal barrier layer.

11. The layer system as claimed in claim 1, where the adhesion promoting layer is at least one of an aluminum oxide layer or an oxide layer grown from the adhesion-promoting layer, and wherein the metallic adhesion-promoting layer is directly on the substrate.

12. The layer system as claimed in claim 1, wherein the outer ceramic layer is an outermost layer of the layer system.

13. The layer system as claimed in claim 1, wherein the outer ceramic layer is at least 50% purer, than the inner ceramic layer in terms of its chemical composition.

14. The layer system as claimed in claim 4, in which the outer ceramic thermal barrier layer has a porosity of between 16% and 24%.

15. The layer system as claimed in claim 6, in which the outer ceramic thermal barrier layer has a porosity of 20%.

16. The layer system as claimed in claim 6, in which at least one of the inner ceramic layer and of the outer ceramic layer further comprises partially stabilized zirconium oxide.

17. The layer system as claimed in claim 16, in which at least one of the material of the inner ceramic layer and of the outer ceramic layer further comprises yttrium-stabilized zirconium oxide.

18. The layer system as claimed in claim 17, in which the yttrium fraction is 8 wt %.

19. The layer system as claimed in claim 10, wherein the outer ceramic thermal barrier layer is at least 20% thicker than the inner ceramic thermal barrier layer.
